(19) United States
(12) Patent Application Publication
(10) Pub. No.: US 2025/0343278 A1
(43) Pub. Date: Nov. 6, 2025

(54) DETECTION AND MITIGATION OF COOLANT LEAKS IN MULTIPLE BRANCH COOLANT SYSTEM

(71) Applicant: GM GLOBAL TECHNOLOGY OPERATIONS LLC, Detroit, MI (US)

(72) Inventors: Justin A. Bunnell, Farmington Hills, MI (US); Andres V. Mituta, Lake Orion, MI (US); Benjamin C. Groen, Troy, MI (US); Philip J. Prociw, Clinton Township, MI (US)

(73) Assignee: GM GLOBAL TECHNOLOGY OPERATIONS LLC, Detroit, MI (US)

(21) Appl. No.: 18/651,904

(22) Filed: May 1, 2024

(51) Int. Cl. H01M 10/42; B60L 50/60; B60L 58/26; G01M 3/16; G01M 3/20; H01M 10/613; H01M 10/625; H01M 10/63; H01M 10/6568

(52) U.S. Cl. CPC H01M 10/4228; B60L 50/60; B60L 58/26; G01M 3/16; G01M 3/20; H01M 10/613; H01M 10/625; H01M 10/63; H01M 10/6568; H01M 2220/20

(57) ABSTRACT

A coolant leak detection and mitigation system for a multi-cell rechargeable energy storage system (RESS) having a plurality of battery cells arranged in individual battery modules includes a cooling system. The cooling system has a main coolant loop circulating coolant and a plurality of coolant branches arranged in parallel. Each coolant branch receives a portion of the coolant from the main coolant loop to adjust the temperature of one battery module. The cooling system also has flow-valve(s) for regulating and distributing the coolant from the main coolant loop across the coolant branches. The leak detection and mitigation system also includes an electronic controller configured to monitor the coolant branches for coolant leaks via coolant leak detection technique(s). The controller is also configured to identify a coolant branch having a coolant leak and shut off, via the flow-valve(s), coolant flow into the coolant branch having the coolant leak.

### INTRODUCTION

The present disclosure relates to detection and mitigation of coolant leaks in a multiple branch coolant system for a multi-cell rechargeable energy storage system (RESS).

Typically, an electric energy generation and storage battery system includes one or more battery cells for powering a load. A plurality of battery cells may be arranged in close proximity to one another to generate a battery module and a plurality of battery modules may be organized into a battery pack array. Batteries may be broadly classified into primary and secondary batteries. Primary batteries, also referred to as disposable batteries, are intended to be used until depleted, after which they are simply replaced with new batteries. Secondary batteries, more commonly referred to as rechargeable batteries, employ specific chemistries permitting such batteries to be repeatedly recharged and reused, therefore offering economic, environmental, and ease-of-use benefits compared to disposable batteries.

Rechargeable batteries may be used to power such diverse items as toys, consumer electronics, and motor vehicles. Particular chemistries of rechargeable batteries, such as lithium-ion cells, as well as external factors, may cause internal reaction rates generating significant amounts of thermal energy. Exposure of a battery cell to elevated temperatures over prolonged periods may cause the cell to experience a thermal runaway event, where heat build-up in an individual cell leads to the heat spreading to adjacent cells in the module and affecting the entire battery array. Accordingly, thermal energy needs to be effectively removed to mitigate heat build-up and consequent degradation of battery system performance. Generally, devices such as heat-sinks or cold-plates with circulating coolant are employed to remove heat from battery systems.

### SUMMARY

A coolant leak detection and mitigation system for a multi-cell rechargeable energy storage system (RESS) having a plurality of battery cells arranged in individual battery modules includes a cooling system. The cooling system has a main coolant loop configured to circulate coolant. The cooling system also has a plurality of coolant branches arranged fluidly in parallel. Each coolant branch is configured to receive a portion of the coolant from the main coolant loop to adjust the temperature of one of the respective battery modules. The cooling system additionally has at least one flow-valve configured to regulate and distribute across the plurality of coolant branches the coolant circulated through the main coolant loop. The coolant leak detection and mitigation system also includes an electronic controller in operative communication with the cooling system. The electronic controller is configured to monitor the plurality of coolant branches for coolant leaks via at least one coolant leak detection technique. The electronic controller is also configured to identify a coolant branch, from among the plurality of coolant branches, having a coolant leak. The electronic controller is additionally configured to shut off, via the flow-valve(s), a flow of the coolant into the coolant branch having the coolant leak.

The electronic controller may be additionally configured to set an alert indicative of the coolant branch having the coolant leak and the flow of the coolant having been shut off.

Each battery module may include a first sensor in communication with the electronic controller and configured to detect a coolant leak via a change in electrical resistance of the first sensor. Determination of electrical resistance of the first sensor provides a first embodiment of the coolant leak detection technique.

The coolant may include a fluorescent dye. In such an embodiment, each battery module may include a second sensor in communication with the electronic controller and configured to detect a coolant leak via detection of the fluorescent dye. The second sensor thereby provides another embodiment of a coolant leak detection technique. Detection of the fluorescent dye within a battery module via the second sensor provides a second embodiment of the coolant leak detection technique.

The multi-cell RESS may be connected to a high-voltage BUS. In such an embodiment, the electronic controller may be additionally configured to identify a coolant branch having a coolant leak via an isolation measurement of the individual battery modules' electrical resistance. Isolation measurement of battery module electrical resistances provides a third embodiment of the coolant leak detection technique.

The electronic controller may be configured to identify the coolant branch having a coolant leak via at least two individual coolant leak detection techniques to distinguish a coolant leak from condensation internal to the corresponding battery module enclosure, but external to the subject coolant branch.

The flow-valve may be a multi-way valve assembly arranged in a junction between the main coolant loop and the plurality of coolant branches. Such a multi-way valve may be configured to control the flow of the coolant into each of the coolant branches.

Alternatively, a plurality of throttle valves may regulate the flow of the coolant from the main coolant loop. Each throttle valve may be arranged in one of the coolant branches upstream of the corresponding battery module and be configured to control the flow of the coolant into the subject coolant branch.

Each coolant branch may include a one-way valve configured to control the flow of the coolant out of the subject coolant branch.

The cooling system may also include a fluid pump configured to circulate the coolant through the main coolant loop.

A motor vehicle employing a coolant leak detection and mitigation system, as described above, and a method of detecting and mitigating a coolant leak in a multi-cell rechargeable energy storage system (RESS) are also disclosed.

The above features and advantages, and other features and advantages of the present disclosure, will be readily apparent from the following detailed description of the embodiment(s) and best mode(s) for carrying out the described disclosure when taken in connection with the accompanying drawings and appended claims.

### BRIEF DESCRIPTION OF THE DRAWINGS

FIG. 1 is a schematic top view of an embodiment of a motor vehicle employing multiple power-sources and a multi-cell rechargeable energy storage system (RESS) configured to generate and store electrical energy used by vehicle systems including the power-sources, according to the disclosure.

FIG. 2 is a schematic illustration of the RESS shown in FIG. 1, including an embodiment of a coolant system having a main coolant loop and multiple parallel coolant branches subsystem for removing thermal energy from individual battery modules and sensors for detecting coolant leaks within the coolant branches, according to the disclosure.

FIG. 3 is a schematic illustration of the RESS shown in FIG. 1, including another embodiment of a coolant system having a main coolant loop and multiple parallel coolant branches subsystem for removing thermal energy from individual battery modules and sensors for detecting coolant leaks within the coolant branches, according to the disclosure.

FIG. 4 illustrates a method of detecting and mitigating a coolant leak in the multi-cell RESS shown in FIGS. 1-3.

### DETAILED DESCRIPTION

Embodiments of the present disclosure as described herein are intended to serve as examples. Other embodiments may take various and alternative forms. Additionally, the drawings are generally schematic and not necessarily to scale. Some features may be exaggerated or minimized to show details of particular components. Therefore, specific structural and functional details disclosed herein are not to be interpreted as limiting, but merely as a representative basis for teaching one skilled in the art to variously employ the present disclosure.

Certain terminology may be used in the following description for the purpose of reference only, and thus are not intended to be limiting. For example, terms such as “above” and “below” refer to directions in the drawings to which reference is made. Terms such as “front”, “back”, “fore”, “aft”, “left”, “right”, “rear”, “side”, “upward”, “downward”, “top”, and “bottom”, etc., describe the orientation and/or location of portions of the components or elements within a consistent but arbitrary frame of reference, which is made clear by reference to the text and the associated drawings describing the components or elements under discussion.

Furthermore, terms such as “first”, “second”, “third”, and so on may be used to describe separate components. Such terminology may include the words specifically mentioned above, derivatives thereof, and words of similar import, and are used descriptively for the figures, and do not represent limitations on the scope of the disclosure, as defined by the appended claims. Moreover, the teachings may be described herein in terms of functional and/or logical block components and/or various processing steps. It should be realized that such block components may include a number of hardware, software, and/or firmware components configured to perform the specified functions.

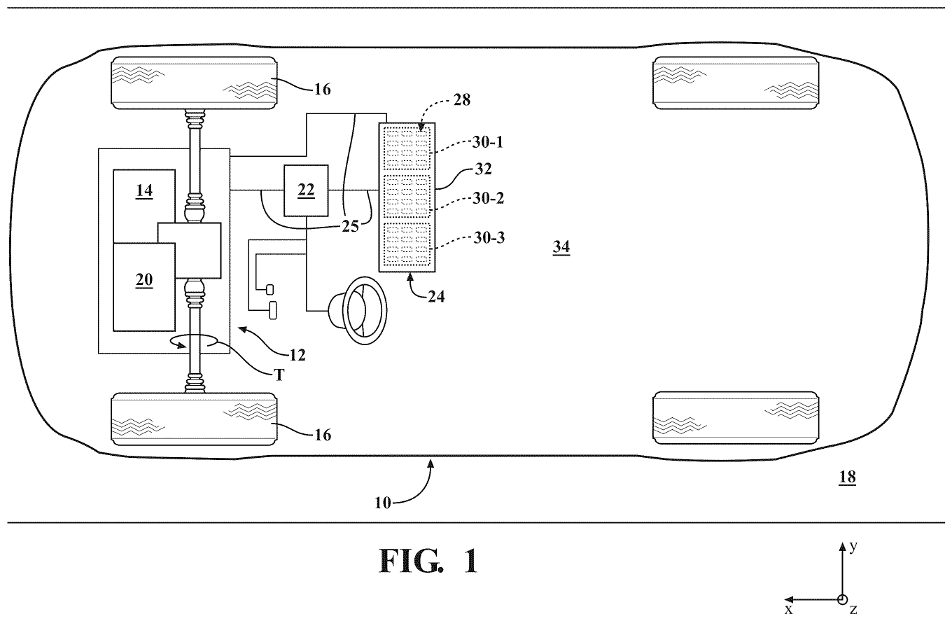

Referring to the drawings, wherein like reference numbers refer to like components, FIG. 1 shows a schematic view of a motor vehicle 10 having a powertrain 12. The vehicle 10 may include, but not be limited to, a commercial vehicle, industrial vehicle, passenger vehicle, aircraft, watercraft, train or the like. It is also contemplated that the vehicle 10 may be a mobile platform, such as an airplane, all-terrain vehicle (ATV), boat, personal movement apparatus, robot and the like to accomplish the purposes of this disclosure. The powertrain 12 includes a power-source 14 configured to generate a power-source torque T (shown in FIG. 1) for propulsion of the vehicle 10 via driven wheels 16 relative to a road surface 18. The power-source 14 is depicted as an electric motor-generator.

As shown in FIG. 1, the powertrain 12 may include an additional power-source 20, such as an internal combustion engine. The power-sources 14 and 20 may act in concert to power the vehicle 10. The vehicle 10 additionally includes a central processing unit (CPU) 22 and a multi-cell rechargeable energy storage system (RESS) 24 configured to generate and store electrical energy through heat-producing electro-chemical reactions for supplying the electrical energy to the power-sources 14 and 20. The CPU 22 regulates various systems of the vehicle 10, including the powertrain 12 to generate a predetermined amount of power-source torque T. The RESS 24 may be connected to the power-sources 14 and 20, to the electronic CPU 22, as well as to other vehicle systems via a high-voltage databus or BUS 25.

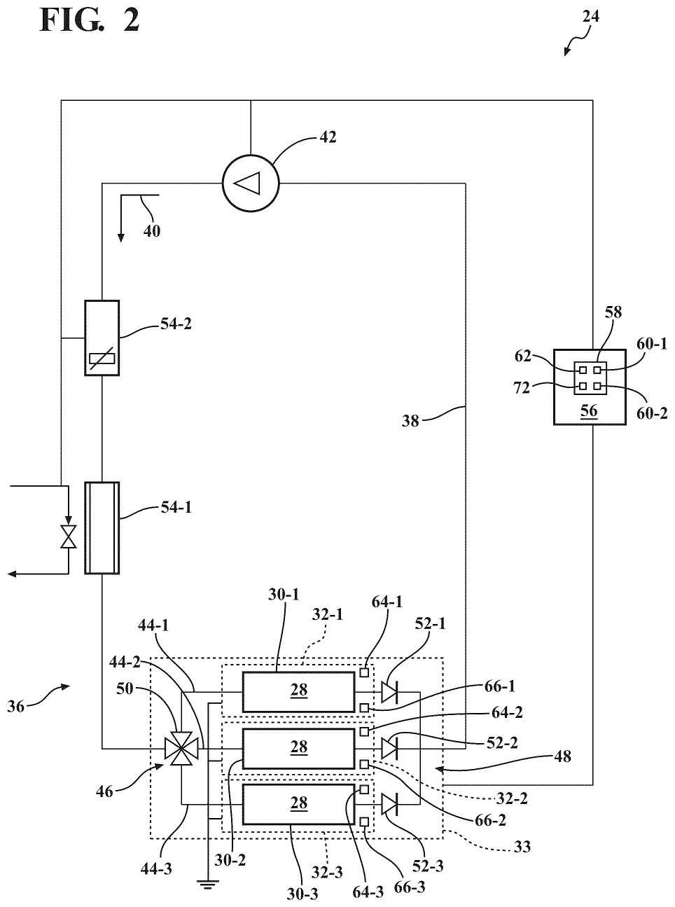

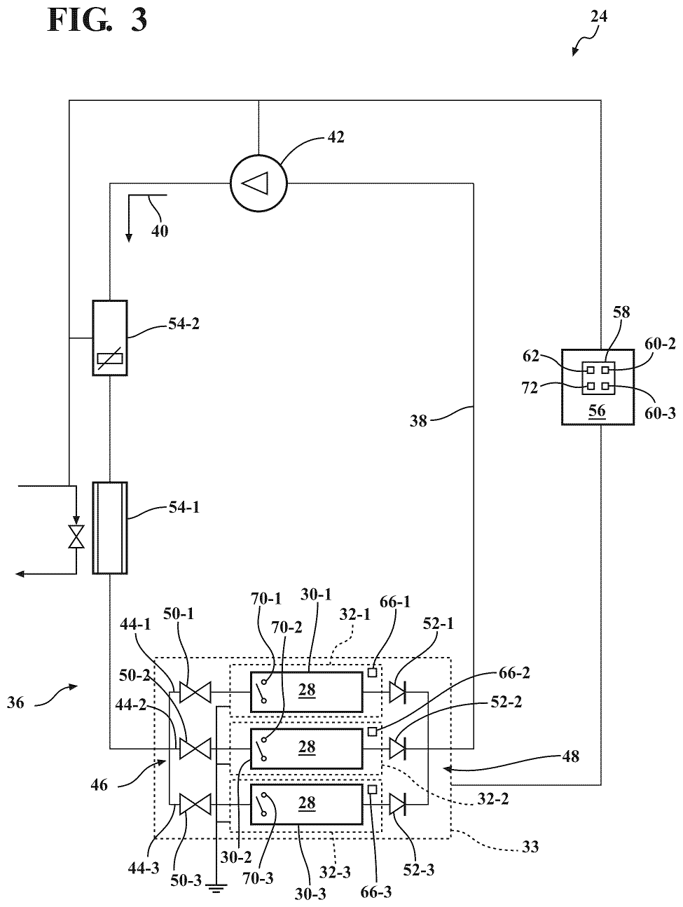

As shown in FIGS. 1-3, the RESS 24 includes a plurality of battery cells 28 arranged in individual battery groups or modules, such as a first module 30-1, a second module 30-2, and a third module 30-3. The subject modules 30-1, 30-2, 30-3 may be arranged electrically in series or in parallel. Although three individual battery modules are specifically shown, it is intended that the RESS 24 includes at least two respective modules, and multiple modules may be organized into battery packs or subpacks. The remainder of the present description will focus on RESS 24 construction having three battery modules 30-1, 30-2, 30-3, with each battery module having a desired quantity of battery cells 28. As shown in FIGS. 2 and 3, each battery module 30-1, 30-2, 30-3 includes a respective battery module enclosure 32-1, 32-2, 32-3 connected to chassis ground and configured to house and support the corresponding battery cells 28. The RESS 24 may also include a battery pack enclosure 33 surrounded by an ambient environment 34 and configured to house and support the battery modules 30-1, 30-2, 30-3 (shown in FIG. 1).

As shown in FIGS. 2 and 3, RESS 24 also includes a cooling system 36 configured to remove thermal energy from various temperature sensitive components of the RESS. Cooling system 36 includes a main coolant loop 38 configured to circulate a coolant 40 through the RESS 24. As shown, cooling system 36 further includes a fluid pump 42 configured to circulate coolant 40 through the main coolant loop 38. The cooling system 36 also includes a plurality of coolant branches, shown as a first branch 44-1, a second branch 44-2, and a third branch 44-3, in fluid communication with the main coolant loop 38. Each of the coolant branches 44-1, 44-2, 44-3 extends through a respective battery module 30-1, 30-2, 30-3, proximate and along the constituent battery cells 28.

Furthermore, each coolant branch 44-1, 44-2, 44-3 is configured to receive a portion of the coolant 40 from the main coolant loop 38. The coolant branches 44-1, 44-2, 44-3 are arranged fluidly in parallel to receive respective portions of the coolant 40. The coolant branches 44-1, 44-2, 44-3 are thereby configured to independently circulate their respective portions of the coolant 40 and adjust the temperature of the corresponding battery modules 30-1, 30-2, 30-3 (by removing or adding thermal energy). Accordingly, each coolant branch 44-1, 44-2, 44-3 passes through one of the battery module enclosures 32-1, 32-2, 32-3. As shown, the main coolant loop 38 may be in fluid communication with additional parallel coolant branches, for example to circulate the coolant through auxiliary power modules (APMs), a Battery Disconnect Unit (BDU) including various electrical switches and relays, electrical connectors, a DC/DC converter for supplying 12V/48V power to the vehicle, etc., each having a particular temperature requirement.

With continued reference to FIGS. 2 and 3, the RESS 24 may also include an inlet manifold 46 configured to connect the main coolant loop 38 to the coolant branches 44-1, 44-2, 44-3 and an outlet manifold 48 configured to connect the coolant branches back to the main coolant loop. Accordingly, the inlet and outlet manifolds 46, 48 are together configured to maintain circulation of coolant 40 through the cooling system 36. The cooling system 36 additionally includes at least one flow-valve 50. The flow-valve(s) 50 are configured to regulate and distribute across the individual coolant branches 44-1, 44-2, 44-3, the coolant 40 circulated through and received from the main coolant loop 38. In other words, the flow-valve(s) 50 are specifically structured and operated to provide independent regulation of coolant flow into each individual coolant branch 44-1, 44-2, 44-3.

As shown in FIG. 2, the flow-valve 50 may be a multi-way valve assembly arranged in a junction, such as the inlet manifold 46, between the main coolant loop 38 and the plurality of coolant branches 44-1, 44-2, 44-3 upstream of each battery module 30-1, 30-2, 30-3. The multi-way valve assembly embodiment of the flow-valve 50 may be configured to control the flow of coolant 40 into each of the coolant branches 44-1, 44-2, 44-3. As shown in FIG. 3, the flow-valve(s) 50 may be a plurality of individual throttle valves 50-1, 50-2, 50-3. Each subject throttle valve 50-1, 50-2, 50-3 may be arranged in one of the plurality of coolant branches 44-1, 44-2, 44-3 upstream of the corresponding battery module 30-1, 30-2, 30-3 and configured to control the flow of the coolant 40 into the subject coolant branch.

As shown in FIGS. 2 and 3, each coolant branch 44-1, 44-2, 44-3 may include a respective one-way valve 52-1, 52-2, 52-3. The one-way valves 52-1, 52-2, 52-3 are configured to prevent backflow of the coolant 40 into the corresponding coolant branches 44-1, 44-2, 44-3. Each of the one-way valves 52-1, 52-2, 52-3 is arranged aft of the flow-valve(s) 50 and downstream of the corresponding battery module 30-1, 30-2, 30-3. Accordingly, each one-way valve 52-1, 52-2, 52-3 is configured to control the flow of the corresponding portion of the coolant 40 through and out of the subject coolant branch 44-1, 44-2, 44-3. Cooling system 36 may also include a plurality of heat exchangers arranged in the main coolant loop 38 to alter the temperature of the coolant 40. For example, one embodiment of such a heat exchanger may be a coolant chiller 54-1, for example, using a refrigerant, to remove thermal energy from the coolant 40 in the main coolant loop 38. Another embodiment of such a heat exchanger may be a coolant heater 54-2, for example, using electrical resistance, to add thermal energy to the coolant 40.

As shown in FIGS. 2 and 3, the multi-cell RESS 24 may additionally include an electronic controller 56 that may be either electronically connected to or be part of the CPU 22. The electronic controller 56 may be configured or programmed to regulate operation of the cooling system 36 or be structured to manage operation of the RESS 24 as a whole. As shown, the electronic controller 56 is in operative communication with the fluid pump 42, the flow-valve(s) 50, the coolant chiller 54-1, and the coolant heater 54-2. To support requisite management of the RESS 24 and/or the cooling system 36, the electronic controller 56 specifically includes a processor and tangible, non-transitory memory, which includes requisite instructions programmed therein. The controller's memory may be an appropriate recordable medium that participates in providing computer-readable data or process instructions. Such a recordable medium may take many forms, including but not limited to non-volatile media and volatile media.

Non-volatile media for electronic controller 56 may include, for example, optical or magnetic disks and other persistent memory. Volatile media may include, for example, dynamic random-access memory (DRAM), which may constitute a main memory. The instructions programmed into the controller 56 may be transmitted by one or more transmission medium, including coaxial cables, copper wire and fiber optics, including the wires that comprise a system bus coupled to a processor of a computer, or via a wireless connection. Memory of the electronic controller 56 may also include a flexible disk, hard disk, magnetic tape, another magnetic medium, a CD-ROM, DVD, another optical medium, etc. The electronic controller 56 may be configured or equipped with other required computer hardware, such as a high-speed clock, requisite Analog-to-Digital (A/D) and/or Digital-to-Analog (D/A) circuitry, input/output circuitry and devices (I/O), as well as appropriate signal conditioning and/or buffer circuitry.

The electronic controller 56 may be configured to regulate the flow of coolant 40 into the individual battery modules 30-1, 30-2, 30-3 via the fluid pump 42 and the flow-valve(s) 50. Algorithm(s), indicated generally via numeral 58, required by the electronic controller 56 or accessible thereby may be stored in the memory of the controller and automatically executed to facilitate operation of the RESS 24 and/or the cooling system 36. Specifically, the algorithm(s) 58 include an inventory mode configured to monitor, via at least one coolant leak detection technique or subroutine, the plurality of coolant branches 44-1, 44-2, 44-3 for coolant leaks. One or more individual detection techniques, indicated via numerals 60-1, 60-2, and 60-3 and to be described below, may be programmed into the electronic controller 56 for monitoring coolant leaks in the coolant branches 44-1, 44-2, 44-3. The coolant branches 44-1, 44-2, 44-3 may be monitored or assessed for coolant leaks continuously, at regular time intervals, or at every key-on of the vehicle 10. As will become apparent below, the individual detection techniques 60-1, 60-2, 60-3 focus on monitoring individual battery modules 30-1, 30-2, 30-3 internally to respective battery module enclosures 32-1, 32-2, 32-3, but externally to actual coolant branches 44-1, 44-2, 44-3.

The electronic controller 56 is also configured to identify a coolant branch from among the branches 44-1, 44-2, 44-3 that is affected by a coolant leak. For example, the coolant branch 44-1 may be recognized as having the leak. The controller 56 is also programmed to shut off the flow of coolant 40 into the coolant branch that has a coolant leak, e.g., the branch 44-1, via the flow-valve(s) 50. In such a case, the coolant flow may be shut off to the branch 44-1 using the multi-way valve 50 or the throttle valve 50-1. The electronic controller 56 may be additionally configured to set, i.e., command or trigger, an alert 62 indicative of the coolant branch having the coolant leak and the flow of the coolant having been shut off to that branch. In other words, the alert 62 may inform a system user or a technician directly via a sensory signal or a trouble code or via a remote server (not shown) that a specific coolant branch is compromised and coolant flow therethrough has been blocked.

As shown in FIG. 2, each battery module 30-1, 30-2, 30-3 may include a respective first sensor 64-1, 64-2, 64-3 in communication with the electronic controller 56. Each first sensor 64-1, 64-2, 64-3 is arranged external to the corresponding coolant branch 44-1, 44-2, 44-3, within a corresponding battery module enclosure 32-1, 32-2, 32-3, e.g., proximate the enclosure tray (not shown), where a leaking coolant is likely to pool. The coolant leak in a particular branch 44-1, 44-2, 44-3 may be detected via a change in electrical resistance of the corresponding first sensors 64-1, 64-2, 64-3. The presence of a sufficient amount of coolant 40 on the first sensor 64-1, 64-2, 64-3 would generate a short circuit across the sensor's terminals and drastically reduce the effective electrical resistance of the subject sensor. Such reduction in the first sensor's resistance may then be communicated to the electronic controller 56 as a first coolant leak detection technique 60-1 (shown in FIG. 2).

Alternatively, the coolant 40 may include a fluorescent dye. As shown in FIGS. 2 and 3, each battery module 30-1, 30-2, 30-3 may include a respective second sensor 66-1, 66-2, 66-3 arranged external to the corresponding coolant branch 44-1, 44-2, 44-3 and in communication with the electronic controller 56. Each second sensor 66-1, 66-2, 66-3 may, for example, be an ultraviolet (UV) light emitting lamp configured to detect the presence of fluorescent dye external to a respective coolant branch 44-1, 44-2, 44-3 but inside the corresponding battery module enclosure 32-1, 32-2, 32-3 as an indicator of a coolant leak therein. Each second sensor 66-1, 66-2, 66-3 may be arranged within the respective battery module 30-1, 30-2, 30-3 to more effectively detect the coolant where it is likely to pool, e.g., proximate the enclosure tray. The detection of fluorescent dye is communicated by the respective second sensor 66-1, 66-2, 66-3 to the electronic controller 56 as a second coolant leak detection technique 60-2 (shown in FIGS. 2 and 3).

The electronic controller 56 may be additionally programmed to identify a coolant branch 44-1, 44-2, and/or 44-3 having a coolant leak via isolation measurement of individual battery modules' electrical resistance. The isolation measurement may be enabled by respective switches 70-1, 70-2, and 70-3 shown in FIG. 3. The subject isolation measurement includes successively connecting one of the battery modules 30-1, 30-2, 30-3 to the high-voltage BUS 25, while disconnecting the remaining battery modules from the BUS via respective switches 70-1, 70-2, 70-3, and then repeating the same for the other modules. In other words, the electronic controller 56 would connect each battery module 30-1, 30-2, 30-3 one at a time to the high-voltage BUS 25.

While one of the battery modules 30-1, 30-2, 30-3 is connected, the electrical resistance of the corresponding module 30-1, 30-2, or 30-3 would be determined using the subject module's electrical circuit connected to the high-voltage BUS 25. The electronic controller 56 may be programmed with a threshold value 72 for electrical resistance characteristic of a dry battery module. The presence of a significant amount of coolant 40 over the battery module terminals would drive down the battery module's electrical resistance and may even generate a short circuit. The resultant electrical resistance of the battery module with a coolant leak would therefore fall below the threshold value 72. Thus, the isolation measurement electrical resistance of each battery module 30-1, 30-2, 30-3 may be determined and compared to the threshold value 72 as a third coolant leak detection technique 60-3 (shown in FIG. 3).

The electronic controller 56 may be configured to perform at least two of the three coolant leak detection techniques 60-1, 60-2, 60-3 to identify the coolant branch 44-1, 44-2, 44-3 affected by a coolant leak. Such duplicate or confirmatory coolant leak detection may be used to verify or ensure confidence in the result prior to commanding stoppage of coolant flow through the suspected branch. For example, the electronic controller 56 may be programmed to run the coolant leak detection techniques 60-1 and 60-2 (shown in FIGS. 2) or 60-2 and 60-3 (shown in FIG. 3). Specifically, using two or more individual coolant leak detection techniques in the cooling system 36 is intended to aid in distinguishing a coolant leak from condensation in the battery module enclosures 32-1, 32-2, 32-3, but external to the corresponding coolant branches. The detection technique 60-2 may therefore be used to confirm the leak assessment, because condensation would not trigger sensors 66-1, 66-2, 66-3.

In addition to monitoring individual coolant branches 44-1, 44-2, 44-3, the electronic controller 56 may be configured to detect coolant loss in the RESS cooling system 36 via communication with appropriate sensors. The presence of a coolant leak in the RESS cooling system 36 may be detected via assessment of fluid pressure or flow drop in the main coolant loop 38, or a coolant reservoir fluid level drop. Other methods of detecting the presence of a coolant leak in the RESS cooling system 36 may, for example, focus on identifying temperature values outside of a predicted coolant temperature range downstream of the coolant branches 44-1, 44-2, 44-3, an improper change in temperature of a component also cooled by the coolant 40, or improper one-way valve 52-1, 52-2, 52-3 response. The monitoring of individual coolant branches 44-1, 44-2, 44-3 may be initiated based on such detection of a coolant leak within the main coolant loop 38 or the cooling system 36 overall. In the event coolant loss is detected in the cooling system 36 but no coolant leak is identified in the coolant branches 44-1, 44-2, 44-3, the electronic controller 56 may be additionally configured to shut off operation of the fluid pump 42 and trigger a corresponding alert.

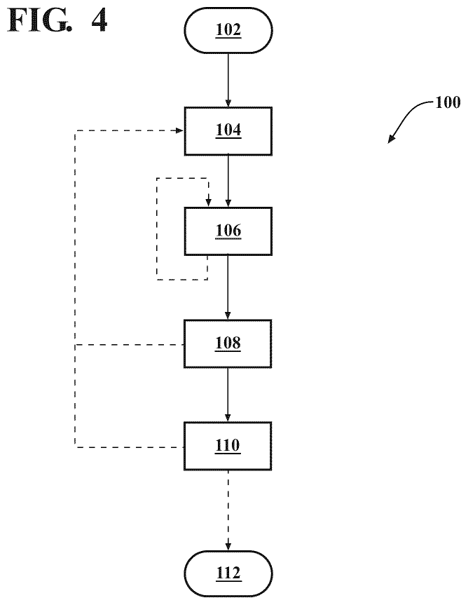

A method 100 of detecting and mitigating a coolant leak in a multi-cell rechargeable energy storage system, such as the RESS 24, as shown in FIG. 4 and described below with reference to the structure shown in FIGS. 1-3. The method is specifically intended for use in the RESS employing a main coolant loop connected to a fluid pump, e.g., the main coolant loop 38, and a plurality of coolant branches, e.g., branches 44-1, 44-2, 44-3, arranged in parallel, each configured to receive a portion of the coolant 40 from the main coolant loop. The subject RESS also employs at least one flow-valve 50 configured to regulate and distribute the coolant 40 received from main coolant loop 38 across the plurality of coolant branches 44-1, 44-2, 44-3.

Method 100 commences in frame 102 with regulating, via the electronic controller 56, flow of coolant 40 in the main coolant loop 38. After frame 102, the method proceeds to frame 104. In frame 104 the method includes monitoring the cooling system 36 for coolant leaks from the coolant branches, e.g., externally to the branches 44-1, 44-2, 44-3, via the electronic controller 56 using one or more of the techniques 60-1, 60-2, 60-3. According to the method, electronic controller 56 may detect the coolant leak via identifying a change in electrical resistance of the respective first sensors 64-1, 64-2, 64-3 as the first coolant leak detection technique 60-1. The controller 56 may also use the second sensors 66-1, 66-2, 66-3 to detect the coolant leak via identifying the presence of fluorescent dye within a particular battery module enclosure 32-1, 32-2, 32-3 but external to the corresponding coolant branch 44-1, 44-2, 44-3 as the second coolant leak detection technique 60-2. According to the method, the electronic controller 56 may additionally employ the isolation measurement of the individual battery modules' electrical resistance, described above with respect to FIGS. 2-3, as the third coolant leak detection technique 60-3.

Following frame 104, the method advances to frame 106. In frame 106, the method includes identifying, via the electronic controller 56, a coolant branch, from among the plurality of coolant branches, e.g., branches 44-1, 44-2, 44-3 described above with respect to FIGS. 2-3, with a coolant leak. According to the method, electronic controller 56 may be programmed to identify the coolant branch affected by a coolant leak via at least two individual coolant leak detection techniques (out of the techniques 60-1, 60-2, and 60-3) to distinguish an actual coolant leak from condensation within the battery module enclosures 32-1, 32-2, 32-3. Therefore, following completion of frame 106, the method may move on to frame 108 or run another of the three leak detection techniques on the identified coolant branch to confirm its identification as the cause of the leak. If the results of the two techniques agree, the method advances to frame 108. If the results of the two techniques disagree, the method may loop back to frame 104 for resumed monitoring of the coolant branches 44-1, 44-2, 44-3.

In frame 108, the method includes shutting off, via the flow-valve(s) 50 regulated by the electronic controller 56, the flow of the coolant 40 into the coolant branch 44-1, 44-2, or 44-3 identified as being affected by the coolant leak. After frame 108, the method may proceed to frame 110. In frame 110, following shutting off the coolant flow into the coolant branch affected by the leak, the method includes setting, via the electronic controller 56, the alert 62 signaling the detected existence of the coolant leak. The alert 62 may identify the affected coolant branch and/or the fact that the flow of the coolant has been shut off. Following either frame 108 or frame 110, the method may loop back to frame 104 for continued monitoring of the coolant branches 44-1, 44-2, 44-3. Otherwise, if the electrical load on the RESS 24 has been removed, e.g., the vehicle 10 has come to a stop, the power-sources 14 and 20 have been switched off, and the fluid pump 42 has been deactivated, the method may conclude in frame 112.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment may be combined with one or a plurality of other desired characteristics from other embodiments, resulting in other embodiments not described in words or by reference to the drawings. Accordingly, such other embodiments fall within the framework and the scope of the appended claims.

What is claimed is:

1. A coolant leak detection and mitigation system for a multi-cell rechargeable energy storage system (RESS) having a plurality of battery cells arranged in individual battery modules, the coolant leak detection and mitigation system comprising:
a cooling system including:
a main coolant loop configured to circulate coolant;
a plurality of coolant branches arranged in parallel, wherein each coolant branch is configured to receive a portion of the coolant from the main coolant loop to adjust temperature of one of the respective battery modules; and
at least one flow-valve configured to regulate and distribute across the plurality of coolant branches the coolant circulated through the main coolant loop; and
an electronic controller in operative communication with the cooling system and configured to:
monitor, via at least one coolant leak detection technique, the plurality of coolant branches for coolant leaks;
identify a coolant branch, from among the plurality of coolant branches, having a coolant leak; and
shut off, via the at least one flow-valve, a flow of the coolant into the coolant branch having the coolant leak.

2. The coolant leak detection and mitigation system of claim 1, wherein the electronic controller is additionally configured to set an alert indicative of the coolant branch having the coolant leak and the flow of the coolant having been shut off.

3. The coolant leak detection and mitigation system of claim 1, wherein each battery module includes a first sensor in communication with the electronic controller and configured to detect a coolant leak via a change in electrical resistance of the first sensor, as a first coolant leak detection technique.

4. The coolant leak detection and mitigation system of claim 1, wherein the coolant includes a fluorescent dye, and wherein each battery module includes a second sensor in communication with the electronic controller and configured to detect a coolant leak via detection of the fluorescent dye, as a second coolant leak detection technique.

5. The coolant leak detection and mitigation system of claim 1, wherein the multi-cell RESS is connected to a high-voltage BUS, and wherein the electronic controller is additionally configured to identify a coolant branch having a coolant leak via an isolation measurement of electrical resistance of the respective battery modules, as a third coolant leak detection technique.

6. The coolant leak detection and mitigation system of claim 1, wherein the electronic controller is configured identify the coolant branch having a coolant leak via at least two individual coolant leak detection techniques to distinguish a coolant leak from condensation internal to the corresponding battery module enclosure, but external to the subject coolant branch.

7. The coolant leak detection and mitigation system of claim 1, wherein the at least one flow-valve is a multi-way valve assembly arranged in a junction between the main coolant loop and the plurality of coolant branches and configured to control a flow of the coolant into each of the coolant branches.

8. The coolant leak detection and mitigation system of claim 1, wherein the at least one flow-valve is a plurality of throttle valves, each throttle valve arranged in one of the plurality of coolant branches upstream of the corresponding battery module and configured to control a flow of the coolant into the subject coolant branch.

9. The coolant leak detection and mitigation system of claim 1, wherein each coolant branch includes a one-way valve configured to control a flow of the coolant out of the subject coolant branch.

10. A method of detecting and mitigating a coolant leak in a multi-cell rechargeable energy storage system (RESS) having a plurality of battery cells arranged in individual battery modules, the method comprising:
monitoring a cooling system for coolant leaks, via an electronic controller using at least one coolant leak detection technique, wherein the cooling system includes:
a main coolant loop configured to circulate coolant;
a plurality of coolant branches arranged in parallel, wherein each coolant branch is configured to receive a portion of the coolant from the main coolant loop to adjust temperature of one of the respective battery modules; and
at least one flow-valve configured to regulate and distribute across the plurality of coolant branches the coolant circulated through the main coolant loop;
identifying, via the electronic controller, a coolant branch, from among the plurality of coolant branches, having a coolant leak; and
shutting off, via the at least one flow-valve, a flow of the coolant into the coolant branch having the coolant leak.

11. The method of claim 10, further comprising setting, via the electronic controller, an alert indicative of the coolant branch having the coolant leak and the flow of the coolant having been shut off.

12. The method of claim 10, wherein each battery module includes a first sensor in communication with the electronic controller, the method further comprising detecting, via at least one of the first sensors, a coolant leak via a change in electrical resistance of the first sensor, as a first coolant leak detection technique.

13. The method of claim 10, wherein the coolant includes a fluorescent dye, and wherein each battery module includes a second sensor in communication with the electronic controller, the method further comprising detecting, via at least one of the second sensors a coolant leak via detection of the fluorescent dye, as a second coolant leak detection technique.

14. The method of claim 10, wherein the multi-cell RESS is connected to a high-voltage BUS, the method further comprising identifying, via the electronic controller, a coolant branch having a coolant leak via an isolation measurement of electrical resistance of the respective battery modules, as a third coolant leak detection technique.

15. The method of claim 10, wherein the method includes identifying, via the electronic controller, the coolant branch having a coolant leak via at least two individual coolant leak detection techniques to distinguish a coolant leak from condensation internal to the corresponding battery module enclosure, but external to the subject coolant branch.

16. A motor vehicle comprising:
an electric motor-generator configured to generate torque;
a multi-cell rechargeable energy storage system (RESS) configured to supply electrical energy to the electric motor-generator, the RESS including:
a plurality of battery cells arranged in individual battery modules; and
a cooling system including:
a main coolant loop configured to circulate coolant;
a plurality of coolant branches arranged in parallel, wherein:
each coolant branch is configured to receive a portion of the coolant from the main coolant loop to adjust temperature of one of the respective battery modules; and
each coolant branch includes a one-way valve configured to control a flow of the coolant out of the subject coolant branch; and
at least one flow-valve configured to regulate and distribute across the plurality of coolant branches the coolant circulated through the main coolant loop; and
an electronic controller in operative communication with the at least one flow-valve and configured to:
regulate operation of the at least one flow-valve;
monitor, via at least one coolant leak detection technique, the plurality of coolant branches for coolant leaks;
identify a coolant branch, from among the plurality of coolant branches, having a coolant leak; and
shut off, via the at least one flow-valve, a flow of the coolant into the coolant branch having the coolant leak.

17. The motor vehicle of claim 16, wherein the electronic controller is additionally configured to set an alert indicative of the coolant branch having the coolant leak and the flow of the coolant having been shut off.

18. The motor vehicle of claim 16, wherein each battery module includes a first sensor in communication with the electronic controller and configured to detect a coolant leak via a change in electrical resistance of the first, as a first coolant leak detection technique.

19. The motor vehicle of claim 16, wherein the coolant includes a fluorescent dye, and wherein each battery module includes a second sensor in communication with the electronic controller and configured to detect a coolant leak via detection of the fluorescent dye, as a second coolant leak detection technique.

20. The motor vehicle of claim 16, wherein the multi-cell RESS is connected to a high-voltage BUS, and wherein the electronic controller is additionally configured to identify a coolant branch having a coolant leak via an isolation measurement of electrical resistance of the respective battery modules, as a third coolant leak detection technique.
